(19) United States
(12) Patent Application Publication
(10) Pub. No.: US 2004/0202479 A1
(43) Pub. Date: Oct. 14, 2004

(54) Transmission configuration

(75) Inventor: Jorg-Reinhart Kropp, Berlin (DE)

Correspondence Address: LERNER AND GREENBERG, PA, P O BOX 2480, HOLLYWOOD, FL, 33022-2480, US

(73) Assignee: Infineon Technologies AG

(21) Appl. No.: 10/810,030

(22) Filed: Mar. 26, 2004

Related U.S. Application Data
(63) Continuation-in-part of application No. 09/520,279, filed on Mar. 6, 2000.

(30) Foreign Application Priority Data
Mar. 4, 1999 (DE) 199 11 433.1

(51) Int. Cl. H04B 10/12

(52) U.S. Cl. 398/143

(57) ABSTRACT

A transmission configuration includes a transmitter for emitting radiation and a multimode optical conductor. The transmitter has a structured laser emitting radiation elements with coupled phases upon stimulation. The structured laser includes at least one structure causing the radiation elements to produce a predetermined higher-order oscillation state. The multimode optical conductor is used for passing on the radiation elements emitted from the transmitter. The radiation elements entering said multimode optical conductor together.

### CROSS-REFERENCE TO RELATED APPLICATION

This is a continuation-in-part of application Ser. No. 09/520,279, filed Mar. 6, 2000

### BACKGROUND OF THE INVENTION

### FIELD OF THE INVENTION

The invention is in the field of optical data transmission with high transmission rates, through the use of multimode optical conductors. Such data transmission is based on the use of optical modules which include an electrooptical transmitter and/or receiver. The transmitter and/or receiver includes a module as an active component which is also referred to as an electrooptical transducer and which generates and emits (transmitter) light signals in the area of an optically active zone when stimulated electrically, and emits corresponding electrical signals (receiver) when light signals are applied to the optically active zone. Laser transmitters are being increasingly used in transmission modules, and are also suitable for satisfying economic aspects of increasingly stringent requirements for high-performance transmitters to generate short, high-quality optical signals or pulses.

The invention relates to a transmission configuration having a transmitter and a multimode optical conductor for passing on radiation emitted from the transmitter.

Such a transmission configuration is described in German Published, Non-Prosecuted Patent Application DE 196 45 295 A1, corresponding to U.S. application Ser. No. 09/301,136, filed Apr. 28, 1999. In that known configuration, an intermediate, additional pin stub including a monomode optical conductor is used for injecting light into one end of a multimode optical conductor. One end surface of the pin stub is in contact with an end of the multimode optical conductor. The light to be injected (for example emitted by a laser diode) is focused onto another, free end surface of the pin stub.

On one hand, in view of the increasing requirement for very high data transmission rates, it is necessary when using a multimode optical conductor (for example to transmit the emitted light signals to a receiver disposed at the other end of the optical conductor) to optimally illuminate the light-carrying core of the multimode optical conductor. On the other hand, the signal response of the laser transmitter must also be such that a required signal form is maintained over a wide operating range. For example, when using square-wave pulses for data coding, the emitted light signal must have a square-wave form which is as ideal as possible, in order to ensure data transmission without bit errors, or at least with few bit errors.

In the known configuration described initially, the pin stub including the monomode optical conductor results in the number of stimulated modes in the downstream multimode optical conductor being reduced. In order to additionally preclude stimulation effects resulting from vagabond light in an outer surface of the pin stub, in order to achieve a wide bandwidth, the pin stub has a light-dissipating region, in which its outer surface is surrounded by an external coating composed of a material having a higher refractive index than the refractive index of the outer surface material.

The known configuration is structurally relatively complex due to the interposition of the pin stub, and does not allow modes to be deliberately stimulated on the end surface of the light-conducting core of the multimode optical conductor or in specific, preferred regions of the core cross section. Since, however, by virtue of the production techniques, the light-conducting core may have poorer light-conduction characteristics in the center and only smaller amounts of light can be transported than in the region where the radii are greater, it is desirable to deliberately stimulate the core in peripheral regions.

### SUMMARY OF THE INVENTION

It is accordingly an object of the invention to provide a transmission configuration which overcomes the hereinafore-mentioned disadvantages of the heretofore-known devices of this general type.

With the foregoing and other objects in view there is provided, in accordance with a first embodiment of the invention, a transmission configuration, comprising a transmitter for emitting radiation, the transmitter having a plurality of individual lasers in a two-dimensional laser array, the individual lasers emitting radiation elements with coupled phases upon stimulation; and a multimode optical conductor for passing on the radiation emitted from the transmitter; the radiation elements entering the multimode optical conductor together.

Laser transmitters which are suitable for this purpose and include a plurality of individual lasers are known per se in conjunction with the investigation of fundamental physical characteristics of lasers, for example from an article entitled “Coherent Beams From High Efficiency Two-Dimensional Surface-Emitting Semiconductor Laser Arrays” by P. L. Gourley et al., Applied Physics Letters 58 (9), 4 Mar. 1991, pages 890-892. That article describes two-dimensional configurations of lasers which are operated non-actively but are stimulated by so-called “photopumps” to emit radiation. The description covers close fields and far fields which are produced. The article does not include any further information relating to active operation of such a laser array in particular for data transmission at high transmission rates.

A major aspect of the present invention, on the other hand, is the simultaneous active operation of a plurality of individual lasers actuating in parallel, for example using the same electrical control signal, which are disposed at a short distance of, for example, 1 to 2 μm from one another. The configuration of the individual lasers in a common configuration (“array”) may be achieved, for example, by structuring the upper and/or lower laser mirror in a vertically emitting laser (VCSEL). In practice, it has been found in that case that even a minor difference in the reflection levels, for example 99.5% in the region of the individual lasers to 98% in the other regions located in between, is sufficient in order to define individual lasers. An alternative or additive option for structuring is to construct electrodes for actuation of the individual lasers as masks, or to structure the active region appropriately. A further major aspect of the configuration according to the invention is that the individual lasers also have the same dynamic response, by virtue of their identical geometries and production processes.

The close proximity of the individual lasers results in the lasers being coupled to one another, in such a manner that a higher-order, two-dimensional, phase-coupled oscillation state is produced. In this oscillation state, it is possible to emit a single mode longitudinally and transversely. The invention makes use of the knowledge that this monomode characteristic leads to a modulation response which provides an advantageous pulse shape for digital transmission, and thus represents a significant improvement in the transmission rates and the transmission capacity.

With such a configuration of individual lasers, it is possible to produce a far field, through the use of which the bandwidth of a multimode optical conductor can be utilized particularly well.

In accordance with another feature of the invention, particularly good utilization of the transmission characteristics of a multimode optical conductor can be advantageously achieved by causing the radiation elements to enter symmetrically about the optical axis of the multimode optical conductor.

In accordance with a further feature of the invention, the geometrical configuration of the individual lasers, in particular in a 2*2 matrix, allows beamforming through the use of a beamforming element disposed between the transmitter and one end of the multimode optical conductor.

In accordance with a concomitant feature of the invention, beamforming is carried out in such a way that the emitted radiation enters predominantly away from the core center, to be precise, in a particularly preferred manner, in the region between 10% and 50% of the core radius. Due to the production and selection processes used for multimode optical conductors, a particularly high transmission rate is normally achieved in this region.

There is further provided in a second embodiment of the invention, a transmission configuration, comprising a transmitter for emitting radiation. The transmitter includes a structured laser emitting radiation elements with coupled phases upon stimulation. The structured laser has at least one structure causing the radiation elements to produce a predetermined higher-order oscillation state. The transmitter further includes a multimode optical conductor for passing on the radiation emitted from the transmitter; the radiation elements entering the multimode optical conductor together.

The term “Higher-order” oscillation state as used herein means that the oscillation state can be any but the ground state.

The form of the structure determines if the oscillation state exists out of a single or a plurality of oscillation modes of the structured laser. The invention provides a way to control the oscillation state of the emitted radiation and influences therefore the pulse shape in a way that is advantageous for digital transmission.

With such a structured laser it is possible to produce a radiation field, through the use of which the bandwidth of a multimode optical conductor can be utilized particularly well.

In accordance with another feature of the invention, the structure is arranged as at least one separating structure forming a plurality of lasers out of the structured laser. The plurality of lasers emits radiation elements with coupled phases upon stimulation. The plurality of lasers operates like the plurality of individual lasers as described above.

This plurality of lasers can be further optimized through arranging the lasers in such close proximity to each other, that the radiation elements form a higher-order conjoint oscillation mode, as described above.

In accordance with a further feature of the invention concerning the structure, the structured laser comprises at least one laser mirror on which the structure is formed by a modification of the laser mirror. Especially a resonator mirror of the laser is applicative for carrying the modification.

Alternatively or additively in accordance with another feature of the invention, the stimulation of the structured laser is carried out electrically by an electrode which is arranged in such a way as to form the structure.

In accordance with a concomitant feature of the invention, the radiation elements are emitted by the structured laser in higher-order oscillation modes and have their radiant power predominantly away from an optical axis of radiation. The optical axis of radiation is located at the center of the emitted radiation and orientated along the direction in which the radiation is propagating.

In a preferred embodiment of the invention, the radiation elements are emitted predominantly in a predetermined distance and/or in a predetermined angle range to the optical axis of radiation, especially symmetrically about the optical axis. This enables the radiation elements to enter a core of the multimode optical conductor at a predetermined distance from a core center of the core.

The transmission of optical signals through a multimode optical conductor is best carried out away from the physical core center. This improves the transmission.

In accordance with an additional feature of the invention, the structure is formed upon a carrier material and orientated in a specific direction relative to a crystal axis of the carrier material. Thus, the structure is aligned more easily on the carrier material.

Other features which are considered as characteristic for the invention are set forth in the appended claims.

Although the invention is illustrated and described herein as embodied in a transmission configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, elevational view of a transmission configuration according to the invention;

FIG. 2 is a fragmentary, elevational view illustrating emission characteristics for a laser array in a 2*2 matrix;

FIG. 3 is an elevational view of a matrix image as shown in FIG. 2, which is enlarged by an optical element, on a light-conducting core of a multimode optical conductor;

FIGS. 4A to 4F are sectional views of structures according to the invention that are formed on a resonator mirror of a structured laser; and

FIGS. 5A to 5C correspond to FIGS. 4A to 4C and show the same structures with resulting oscillation modes.

### DESCRIPTION OF THE PREFERRED EMBODIMENTS

Referring now to the figures of the drawings in detail and first, particularly to FIG. 1 thereof, there is seen a transmission configuration which includes a laser transmitter 1 that emits radiation 2 when electrically actuated in a manner which is known per se. The radiation 2 passes through a beamforming element, in the form of a lens 5, on its way to a multimode optical conductor 3. This broadens the radiation 2, which then arrives at an end surface 6 of a light-conducting core 7 of the multimode optical conductor 3. As will be explained in more detail in the following text, the radiation 2 actually includes a plurality of radiation elements from individual lasers, which are in a phase-coupled oscillation state. The optical conductor 3 has a central optical axis 8. A radiation-emitting end surface 9 of the transmitter 1 is shown considerably enlarged in FIG. 2.

FIG. 2 shows individual lasers 12a to 12d disposed in a 2*2 matrix and having diameters that are each approximately 3 to 5 μm. The individual lasers 12a to 12d are disposed in a common laser array 14 and emit appropriate light signals (laser pulses) when actuated electrically. Inactive regions 15, 16, which functionally isolate the individual lasers from one another, are located between the lasers (for example the lasers 12a and 12b). This isolation can be achieved, for example, by mirror layers that are applied in order to constitute the individual lasers being mirrored to a greater extent in the region of the lasers (with 99.5%, for example), and by the intermediate regions 15, 16 being mirrored to a slightly lesser extent (for example with 98%). The structuring and separation of the individual lasers can, however, also be achieved by also using appropriate electrodes for actuation as masks, and by covering the intermediate regions 15, 16.

The individual lasers may be produced on a common substrate or base material 18. The production of suitable laser arrays is described, for example, in the article mentioned initially in Applied Physics Letters 58(9), 1991, pages 890 to 892. If the individual lasers 12a to 12d are operated in parallel with the same control signal, the close proximity of the lasers to one another results in the lasers being coupled to one another, and thus in coupling of laser-specific radiation elements 19a to 19d, as is merely indicated diagrammatically in FIG. 2. This coupling results in the production of a higher-order, two-dimensional, and phase-coupled oscillation state, which facilitates the emission of a single mode longitudinally and transversely. This monomode characteristic leads to a modulation response, which provides a suitable pulse shape for digital data transmission.

As FIG. 3 shows, the beamforming element 5 shown in FIG. 1 results in an image of the laser array illustrated in FIG. 2 being produced on the end surface 6 of the core 7 of the multimode optical conductor 3. A periphery 20 shown in FIG. 3 indicates a boundary of the light-conducting core 7 which, in conventional multimode optical conductors, has a diameter of approximately 62.5 μm. The configuration described above results in the individual radiation elements 19a to 19d shown in FIG. 2 being imaged symmetrically about a core center Z or about a central longitudinal axis 8 (optical axis) as radiation spots 19A to 19D in a region of approximately 10 to 50% of a core radius R originating from the core center Z. This coupling allows the bandwidth of the multimode optical conductor to be utilized particularly well.

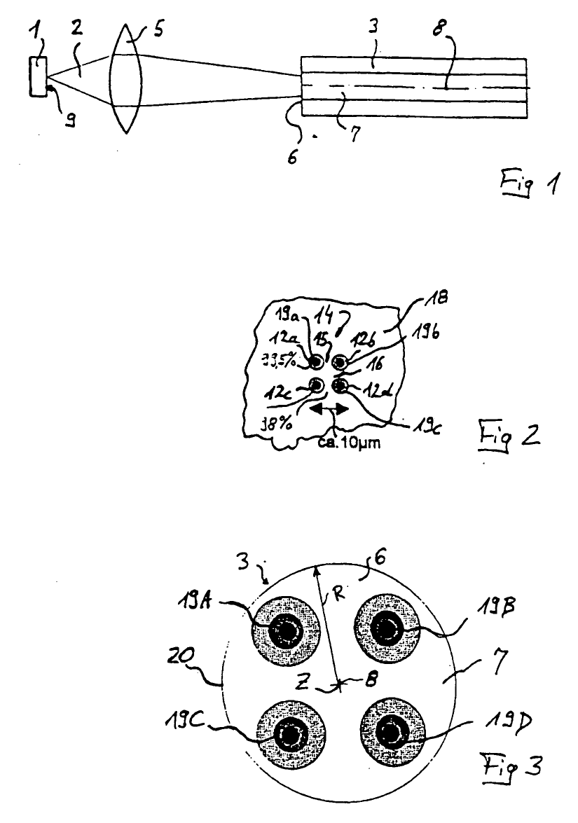

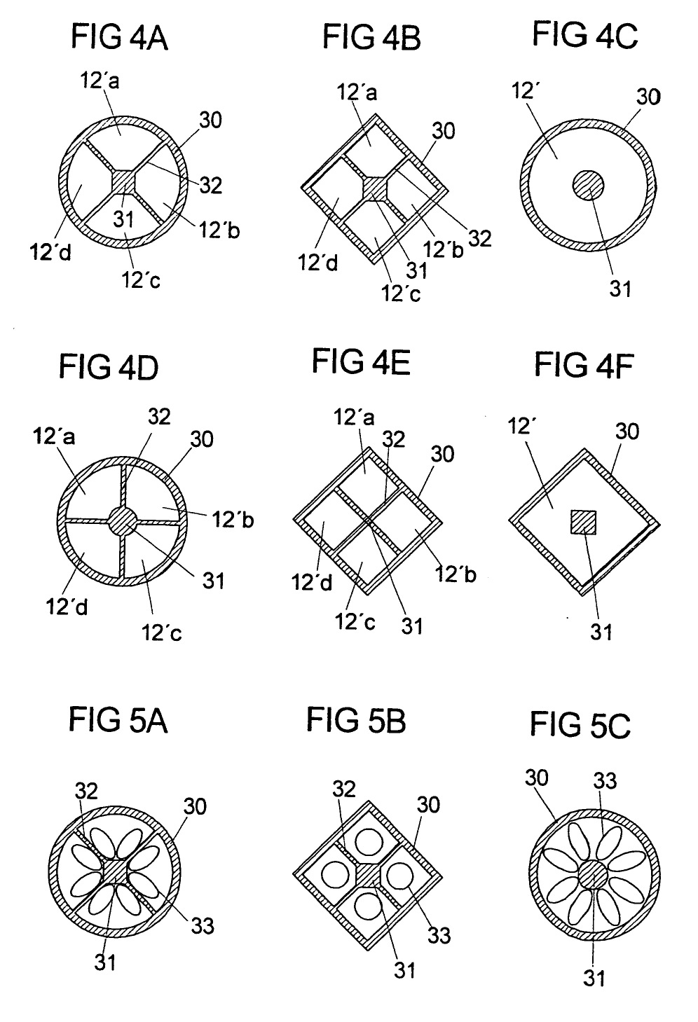

FIGS. 4A to 4F show structures 30, 31, 32 formed on a resonator mirror of a laser. The structures themselves have no or reduced reflectance at the operating wavelengths of the laser and are shown striped. The parts 12′, 12′a, 12′b, 12′c, 12′d of the mirror between the structures shown in white have a high reflectance to provide radiation elements forming a laser beam. Especially VCSEL-Lasers that are operated close to the threshold current show a lower threshold at parts of the resonator mirror having higher reflectance than at parts with lower reflectance. At parts with higher reflectance the stimulation is higher and therefore the threshold current for emitting radiation is reached sooner.

For example, the structure for a VCSEL can have a reflectance of 98% and the parts that emit radiation elements have a reflectance of 99.5%. Furthermore, the structures could be formed by a metallic fitting that influences the reflectance as well.

The structures in the embodiments have either a shape of a circle in FIGS. 4A, 4C, and 4D or a shape of a square in FIGS. 4B, 4E, and 4F. The shape of the structure is defined by a border 30. In the center 31 of each structure is a part of the structure arranged to form a nodal point in the center of the optical axis of the emitted radiation and to reduce radiant power emitted along the optical axis. The nodal point 31 can, for example, be a circle with a diameter smaller than the diameter or the length of its border 30, or a square with a side length smaller than the side length or the diameter of its border 30. Structures in the shape of a circle and in the shape of a square may have a circular center 31 or a square as center 31. Besides, the center 31 can be formed simply by crossing separating structures 32 as shown in FIG. 4E.

In FIG. 4B, for example, both the border 30 and the center 31 have the form of a square. The two squares are aligned opposite to each other.

FIGS. 4C and 4F show the resonator mirror of the laser only with the border 30 and the center 31 as structures, which makes the laser a single, structured laser. Additionally, in the resonator mirrors shown in FIGS. 4A, 4B, 4D, and 4E, the structure shows four rays 32 leading from the center 31 straight to the border 30. Especially, as shown in FIGS. 4A and 4B, the rays 32 lead from the four corners of the center-square 31 to the border 30 and therefore smooth out spikes formed by the corners that would otherwise affect the oscillation state of the structured laser. These rays 32 of the structure form separating structures and separate four parts of the resonator mirror from each other and therefore form four separate lasers 12′a to 12′d aligned in a 2×2-matrix. The rays 32 of the structure are small enough to allow an optical coupling between all four lasers 12′a to 12′d.

The invention is not limited to structures in the shape of circles or squares, but can also have the shape of a cyclic hexamer or any other shape that is preferably symmetrically towards the center 31.

FIGS. 5A to 5C correspond to FIGS. 4A to 4C and show the same structures 30, 31 and in case of FIGS. 5A and 5B even rays 32. Additionally to the structures, the resulting oscillation modes 33 are shown, which are set up after switching on the laser. The resulting oscillation modes are shown in an exemplary manner, since it is also possible for different oscillation modes to appear. For example, an oscillation mode with 4 modes could appear in the structure shown in FIG. 5A instead of an oscillation mode with 8 modes as displayed. It is also possible for a plurality of different modes to emerge from the resonator mirror, having in common that none of the emerging oscillation modes is the ground state.

All the oscillation modes 33 have a circular or elliptical form and a node at the center which is locked by the center 31 of the structure. Furthermore, the oscillation modes are all aligned symmetrically towards the center 31.

The structures formed on the laser mirrors can be combined with structuring the electrode, e.g. using electrode-geometries stimulating exclusively the parts of the laser that produce the oscillation modes desired.

Such structured electrodes can also substitute the structuring of the laser mirror, but preferably both the electrodes and at least one of the resonator mirrors are structured.

Being formed as described above, the radiation elements forming the oscillation modes are emitted and coupled into the multimode optical conductor 3 shown in FIG. 1. The radiation elements enter the conducting core 7 of the multimode optical conductor 3 predominantly away from its core center because of the oscillation mode in which they are emitted. It is shown that especially when the radiation elements enter in the region between 50% and 80% of the core radius, the transmission rate is optimized.

The invention therefore envisages a configuration using phase-coupled, monomode individual lasers or using a structured laser for transmitting data in multimode optical conductors. This results in the advantages of a monomode characteristic with respect to the modulation response, on the one hand, combined with deliberate stimulation of higher modes in the periphery of the core of a multimode optical conductor, on the other hand, using very simple measures.

1. A transmission configuration, comprising:
a transmitter for emitting radiation, said transmitter having a plurality of individual lasers in a two-dimensional laser array, said individual lasers emitting radiation elements with coupled phases upon stimulation, said individual lasers being operated simultaneously; and
a multimode optical conductor for passing on the radiation emitted from said transmitter, said multimode optical conductor having a core with a core center;
said radiation elements entering said multimode optical conductor together, said radiation elements entering symmetrically about an optical axis of said multimode optical conductor; and
the emitted radiation entering said core predominantly away from said core center.

2. The transmission configuration according to claim 1, including a beamforming element through which said radiation elements pass before entering said multimode optical conductor.

3. The transmission configuration according to claim 2, wherein said beamforming element enlarges an optical image of said individual lasers on said core, causing the emitted radiation to enter predominantly away from said core center.

4. The transmission configuration according to claim 1, wherein said core has a core radius, and the emitted radiation enters predominantly in a region between 10% and 50% of said core radius.

5. The transmission configuration according to claim 1, wherein said individual lasers are disposed at a distance of 1 to 2 μm from one another.

6. The transmission configuration according to claim 1, wherein said two-dimensional laser array is formed by a structured laser mirror having a reflection level differing in regions of said individual lasers from other regions located in between said regions of said individual lasers.

7. A transmission configuration, comprising:
a transmitter for emitting radiation, said transmitter having a structured laser emitting radiation elements with coupled phases upon stimulation;
said structured laser including at least one structure causing said radiation elements to produce at least one predetermined higher-order oscillation state;
a multimode optical conductor for passing on the radiation elements emitted from said transmitter; and
said radiation elements entering said multimode optical conductor together.

8. The transmission configuration according to claim 7, wherein said structure is configured as at least one separating structure forming a plurality of lasers out of said structured laser, said plurality of lasers emitting radiation elements with coupled phases upon stimulation.

9. The transmission configuration according to claim 8, wherein lasers of said plurality of lasers are arranged in such close proximity to each other that said radiation elements form a higher-order conjoint oscillation mode.

10. The transmission configuration according to claim 7, wherein said structured laser includes at least one laser mirror and said structure is formed by a modification of said laser mirror.

11. The transmission configuration according to claim 7, wherein said stimulation of said structured laser is carried out electrically by an electrode configured to form said structure.

12. The transmission configuration according to claim 7, wherein said structure is formed upon a carrier material and said structure is orientated in a specific direction relative to a crystal axis of said carrier material.

13. The transmission configuration according to claim 7, wherein said structure is configured to cause said radiation elements to be emitted having more radiant power in higher-order oscillation modes than in the ground mode of said structured laser.

14. The transmission configuration according to claim 7, wherein said structured laser emits radiation elements in higher-order oscillation modes having their radiant power predominantly away from an optical axis of radiation.

15. The transmission configuration according to claim 8, wherein said separating structure reduces oscillation modes having their radiant power predominantly about an optical axis of radiation.

16. The transmission configuration according to claim 7, wherein said radiation elements are emitted predominantly in at least one of a predetermined distance and a predetermined angle range to an axis of radiation.

17. The transmission configuration according to claim 7, wherein said radiation elements are emitted predominantly symmetrically about an optical axis of radiation.

18. The transmission configuration according to claim 7, wherein said multimode optical conductor has a core with a core center, and said emitted radiation elements enter said core predominantly in a predetermined distance from said core center.

19. The transmission configuration according to claim 7, further comprising a beamforming element through which said radiation elements pass before entering said multimode optical conductor.

20. The transmission configuration according to claim 19, wherein said multimode optical conductor has a core with a core center, and said beamforming element enlarges an optical image of said structured laser on said core, causing said emitted radiation elements to enter predominantly in a predetermined radial distance from said core center.

21. The transmission configuration according to claim 7, wherein said structure has a shape of one of a circle and a square forming an outer border to a part of said structured laser emitting the radiation elements.

22. The transmission configuration according to claim 8, wherein said separating structure has multiple rays leading from a center of said structure to a border of said structure.

23. The transmission configuration according to claim 21, wherein said structure is configured as at least one separating structure forming a plurality of lasers out of said structured laser, and said separating structure has multiple rays leading from a center of said structure to said outer border of said structure.
